(19) United States
(12) Patent Application Publication
(10) Pub. No.: US 2005/0160617 A1
(43) Pub. Date: Jul. 28, 2005

(54) Bag with active ventilation

(76) Inventor: Kenneth B. Fouts II, Lexington, KY (US)

Correspondence Address: KING & SCHICKLI, PLLC, 247 NORTH BROADWAY, LEXINGTON, KY, 40507, US

(21) Appl. No.: 10/775,300

(22) Filed: Feb. 10, 2004

Related U.S. Application Data
(60) Provisional application No. 60/536,126, filed on Jan. 13, 2004.

(51) Int. Cl. F26B 19/00

(52) U.S. Cl. 34/202

(57) ABSTRACT

A bag with active ventilation includes an interior and an exterior defined by at least one panel. The bag includes a fan, which may be solar powered, with an air intake and exhaust, the air intake being disposed toward the exterior and the exhaust being disposed toward the interior. The bag includes at least one conduit fluidly connected to the exhaust for distributing air from the intake to the interior during use. Additionally, the bag may include a bladder having a first panel, a second panel, and a plurality of vents for distributing air to the interior of the bag. The bladder also includes supports that prevent compression of the bladder when a load becomes placed on it, such as when articles become placed in the bag. Thus, the supports allow air to distribute through the bladder to all parts of the bag regardless of the bag contents.

This application claims the benefit of U.S. Provisional Patent Application Ser. No. 60/536,126, filed Jan. 13, 2004.

### TECHNICAL FIELD

The present invention relates generally to a bag for storing articles, such as a duffel bag for storing sports equipment, and more specifically, to a bag having a fan for active distribution of air to the interior of the bag. In other aspects the bag includes a conduit, which may include a tube or manifold, and a bladder for distributing air inside the bag. Moreover, the fan may utilize solar power or a rechargeable power source and incorporate a filter utilized for air freshening.

### BACKGROUND OF THE INVENTION

Individuals participate in physical activities on a daily basis. From recreational exercising for fitness to participating in organized sports, almost everyone joins in some level of physical activity. Many individuals own and utilize specialized equipment for use with these activities. For instance, an individual may own running shoes, shorts, t-shirts, and other accessories for participating in these events. Moreover, many sports require specialized equipment such as balls, pads, jerseys, etc. Winter activities such as hockey and snow skiing include equipment such as boots, ice skates, helmets, and goggles.

In order to transport and store the large amount of equipment associated with these activities, many individuals utilize bags, such as duffel bags, for carrying these articles. After participating in a sporting event, an individual's sporting equipment may often be damp or wet from perspiration or from use in the snow or ice. Problematically, many of these bags used for transporting equipment provide little or no ventilation of the articles stored inside. Thus, when an individual transfers wet sporting equipment in a conventional bag, the articles stay wet and often produce mold or mildew.

Problematically, this wet equipment stored in a conventional bag will often omit a foul odor and not fully dry before an individual again desires use of the equipment. This condition is unsanitary and undesirable for the user. Moreover, prolonged wetness of this equipment may lead to premature wear due to deterioration and rot. This requires a user to replace the sporting equipment at a shorter interval than desired, a time consuming and costly problem.

Additionally, many individuals who utilize this equipment are not always in an area where they have access to conventional power supplies and drying equipment, such as a traditional clothes dryer. For example, a professional athlete or an individual on vacation may utilize sporting equipment in a remote location away from drying equipment. Furthermore, these individuals may have the need for repeated use of this equipment over a several day period. Therefore, the need exists for a bag which provides active drying utilizing a renewable power source for use when away from drying equipment.

To address these problems, some bags include passive ventilation measures, such as a mesh material. However, passive ventilation does not adequately dry the articles in a short enough time before an individual again desires their use. Furthermore, when a bag is filled to capacity, the passive ventilation will not adequately supply ventilation to all of the articles in the bag.

Accordingly, the bag arts have need of a bag that provides active ventilation of the contents of the bag thereby quickly drying the stored articles. Moreover, the need exists for a bag that actively ventilates all portions of the bag regardless of the volume of articles stored in the bag. Furthermore, the need exists for a bag that includes a fan powered by a renewable power source for use when away from conventional power supplies and drying equipment.

### SUMMARY OF THE INVENTION

In accordance with the purposes of the present invention as described herein, a new and improved bag is described. The present invention includes a bag having an interior and exterior defined by at least one panel. Additionally, the bag includes fan, which may be solar powered or battery powered, with an air intake and exhaust, the air intake being disposed toward the exterior and the exhaust being disposed toward the interior. The fan may also include a filter for treatment of the air prior to entering the bag. The filter operates to treat the air prior to entering the bag and may function as an air freshener. The bag further includes at least one conduit fluidly connected to the exhaust for distributing air from the intake to the interior during use.

In one embodiment, the conduit comprises a tube having at least one vent along its length. The conduit may terminate with a bladder in fluid communication with the conduit. The bladder includes a proximal and distal end, and a first panel and a second panel defining a void adapted to receive the airstream from the fan. The bladder includes a plurality of vents for distribution of the air to the bag interior. Moreover, the bladder includes a plurality of supports located in the void of the bladder for separating the first panel from the second panel. Air flows in the proximal end of the bladder and around the supports to the distal end. Additionally, air escapes through the vents into the interior of the bag. Thus, even when a load becomes placed on the bladder, the supports permit air distribution to all portions of the bag.

The conduit may also comprise a manifold. The manifold includes an inlet, fluidly connected to the air exhaust, and a plurality of outlets. Therefore, a bladder or tube may simultaneously attach to the manifold for customized airflow configurations. Additionally, caps may attach to the unused outlets of the manifold.

In the following description there is shown and described one possible embodiment of the invention, simply by way of illustration of one of the modes best suited to carry out the invention. As it will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1A is perspective view of a bag in accordance with the present invention;

FIG. 1B is a end view of the bag of FIG. 1A;

FIG. 1C is a side view of the bag of FIG. 1A;

FIG. 1D is an exploded perspective view of the fan of the bag of FIG. 1A;

FIGS. 2A-2G are sectional views along the line A-A of FIG. 1B showing various embodiments of the bag including the fan, conduit, and bladder in accordance with the present invention;

FIG. 3A is a detailed view of the manifold showing an attached bladder, tube, and caps in accordance with the present invention;

FIG. 3B is a detailed top view of a bladder in accordance with the present invention;

FIG. 3C is a detailed view of a bladder in the shape of specific article in accordance with the present invention; and

FIG. 3D is a representative diagram showing the bladder of FIG. 3C inserted in an article in accordance with the present invention.

### DETAILED DESCRIPTION OF THE INVENTION

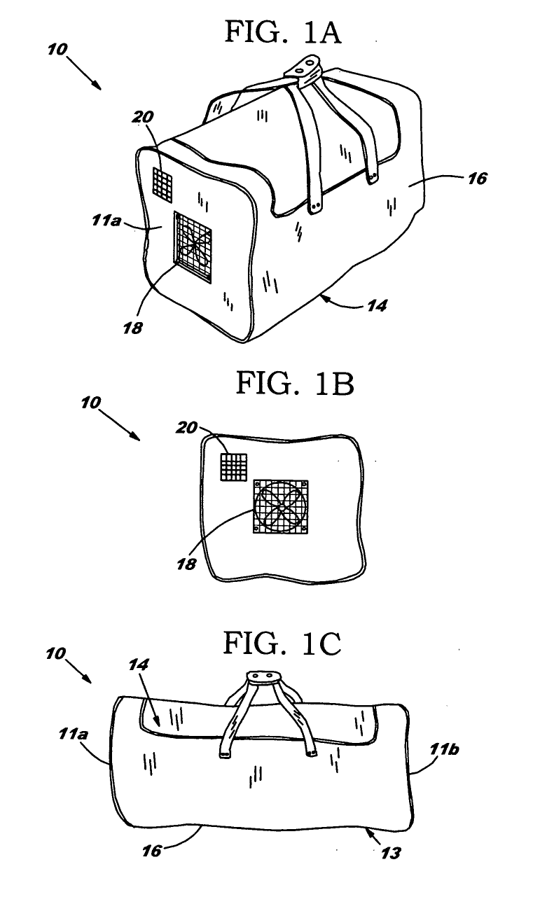

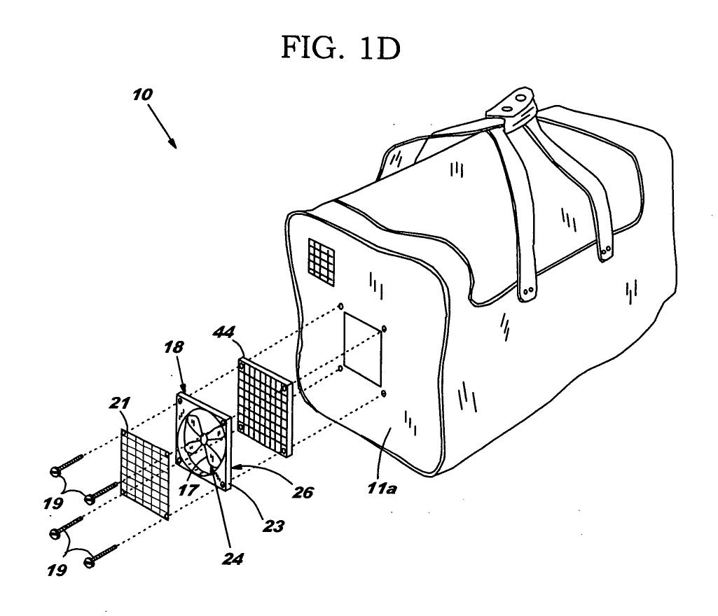

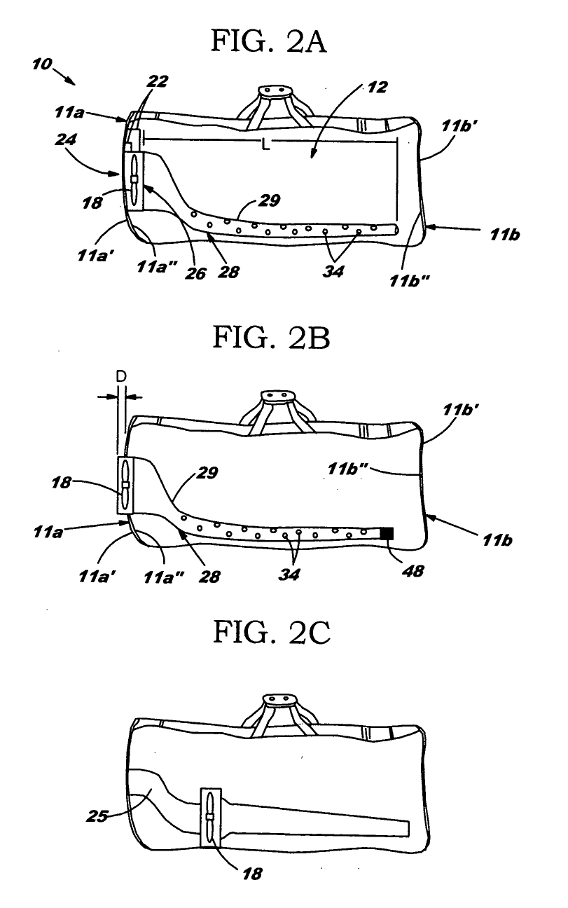

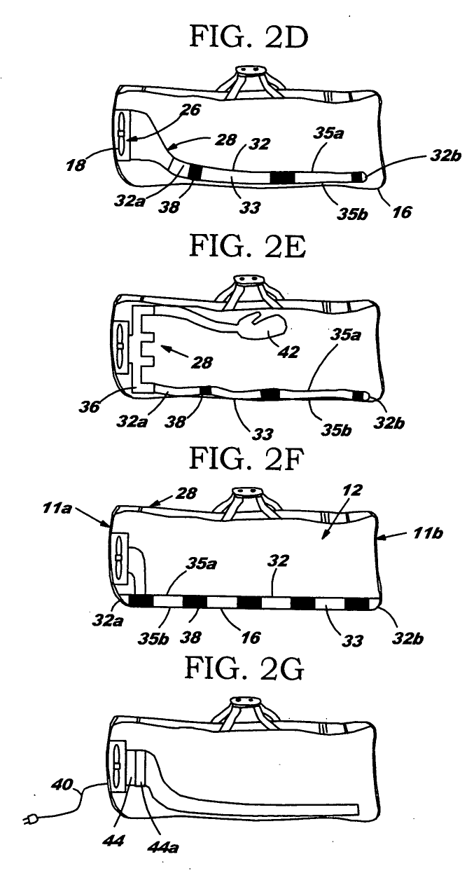

Reference is now made to FIG. 1A-1C and 2A illustrating the bag 10 of the present invention. As illustrated, the bag 10 includes an interior 12, an exterior 14 defined by at least one panel 16, and a fan 18. In one embodiment, the bag 10 takes the form of a cylindrical duffel bag 13 having a first end panel 11a and a second end panel 11b. The first end panel 11a and second end panel 11b each have a first side 11a′, 11b′ and a second side 11a″, 11b″. However, the bag 10 may be any shape, size, or design. The bag may also comprise any material such as nylon, canvas, leather, or any other.

As shown in FIG. 1D, the fan 18 has an air intake 24 and an air exhaust 26. Furthermore, the fan 18 includes a fan cage 23 for supporting a fan blade 17 and a fan motor (not shown). Additionally, the fan 18 may include a grating 21 attached to the fan. The grating 21 helps protect an individual from injury from the fan blade 17 during use.

The fan 18 attaches to the bag 10 in various methods. For example, the fan 18 attaches to the bag 10 via bolts 19 and corresponding nuts (not shown) or other mechanical fastener. The bolts 19 extend through the fan cage 23 and fixedly attach the fan 18 to the bag 10 via the corresponding nuts. Additionally, if the fan is made of a polymeric type material, the fan 18 may attach to the bag 10 via heat sealing, welding, or any other method that provides for attachment of the fan 18 to the bag.

As seen in FIGS. 2A, 2B, and 2C, the fan 18 may become positioned at many locations on the bag. In one embodiment the fan 18 may attach to the bag in a manner such that the air intake 24 is substantially flush with an end panel 11a, 11b. Further, as seen in FIG. 2B, the fan may attach such that the air intake 24 may extend away from the bag interior 12a distance D beyond the first side 11a′, 11b′ of an end panel 11a, 11b, while the exhaust remains in fluid communication with interior. Additionally, the fan 18 may become positioned in the interior 12 of the bag 10 (FIG. 2C). If mounted in the interior 12 of the bag 10, an intake conduit 25 keeps the air intake 24 in fluid communication with the exterior 14 thereby supplying air to the fan 18. Moreover, when positioning the fan in the interior 12 of the bag, the fan may attach directly to the bag 10 or may mount in an auxiliary structure (not shown) in the interior 12, such as a frame or stand adapted to hold the fan. The fan 18 may also attach to the panel 16 in a manner as previously described relative to attaching the fan to the end panel 11a, 11b.

A solar collector 20, shown in FIG. 1A, may supply power to the fan. The solar collector 20, such as a solar cell or panel, may fixedly or removably attach to the bag via sewing, taping, gluing, hook and loop fastener, or any other method. The solar collector may affix anywhere on the bag 10, but would preferably be located on the exterior 14 of the panel 16 or an end panel 11a, 11b. When attached to the bag, the solar collector 20 includes wires 22 for conveying electrical power to the fan 18. Furthermore, similar to the commercially available SOLARVENT brand fan produced by Intersolar, the solar collector 20 may attach directly to the fan 18 in place of or in addition to the grating 21. Thus, by using a solar powered fan, an individual may repeatedly dry or ventilate the articles of the bag 10 while located away from conventional power supplies, such as a standard wall power outlet, or drying sources, such as a traditional clothes dryer.

As an alternative or additional fan power source, the bag may include a power cable 40 (FIG. 2G) or batteries (not shown) such as rechargeable nickel metal hydride (NiMH), nickel cadmium (NiCd), lithium ion (LiIon), disposable alkaline, or any other. These alternative power sources may be used at nighttime when solar power is not optimal or as a supplement to the solar collector 20. Furthermore, if rechargeable batteries are used, the power cable 40 may be used to recharge the batteries. Moreover, the bag 10 may include a power switch (not shown) electrically connected to the fan 18 thereby allowing a user to turn the fan on or off.

Additionally, a filter 44 may attach to the fan 18, via bolts 19 and corresponding nuts (not shown) or other fasteners, for treatment of the air prior to entering the interior 12 of the bag 10. In one embodiment, shown in FIG. 2G, the filter 44 may also include a reservoir 44a for storage of a scented, deodorizing, disinfecting, sterilizing, or other any other type of liquid, gel, or other material for treatment of the air. As shown, the filter and reservoir may embody multiple elements or, alternatively, the filter and reservoir may embody a single, unitary element. Thus, the filter and reservoir may operate as one with the reservoir functioning as the filter. Furthermore, the filter 44 may function to remove particulate matter, such as dust, from the air entering the bag.

In operation, rotation of the fan blade 17 draws air into the air intake 24 and out the air exhaust 26. In one embodiment, a conduit 28 fluidly connects directly to the air exhaust 26 for distributing air into the interior 12 of the bag 10. Referring to FIGS. 2A and 2B, the conduit 28 may comprise a tube 29 having at least one vent 34, which may include an aperture, slit or hole along its length L. The conduit 28 may also terminate with a vent 34. In one embodiment, the vents embody slits of about 3-15 mm. In others, they represent holes having diameters of about 3-10 mm. The conduit 28 may also terminate in a sealed end (such as by use of a cap 48), or any other way. Additionally, the conduit may also include a manifold 36 discussed later in more detail.

In one embodiment, seen in FIG. 2D, the conduit 28 terminates with a bladder 32 in fluid communication with the conduit 28. The bladder functions to distribute air to desired regions in the interior 12 of the bag 10. The bladder 32 includes a first panel 35a, second panel 35b, a void 33 adapted to receive the air from the air exhaust 26 of the fan 18, a proximal end 32a, and a distal end 32b. The bladder 32 may be made of any material suitable for receiving and distributing air to the interior of the bag. For example, the bladder 32 may be formed of a polymeric material such as polyethylene or polypropylene or any other.

The first panel 35a and second panel 35b of the bladder 32 may be formed via one piece of material or multiple pieces sealed together. For instance, the first panel 35a may be heat sealed, glued, taped or otherwise sealingly joined with the second panel 35b. Alternatively, the first panel 35a and second panel 35b may be integrally formed via a single piece of material, such as an extruded bag or tube. The bladder 32 proximal end 32a may removably attach to the conduit 28 via standard hose or tube fittings (not shown) or may become integrally attached to the conduit via heat sealing, welding, or any other method.

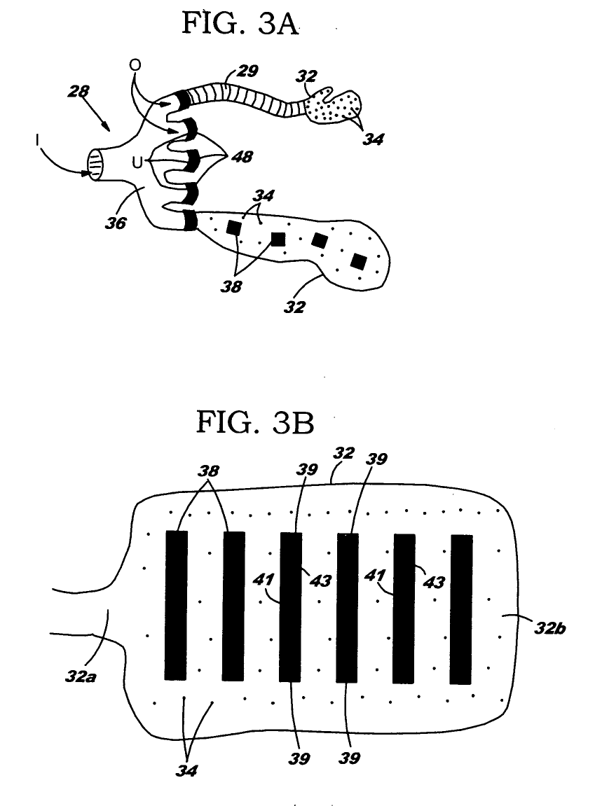

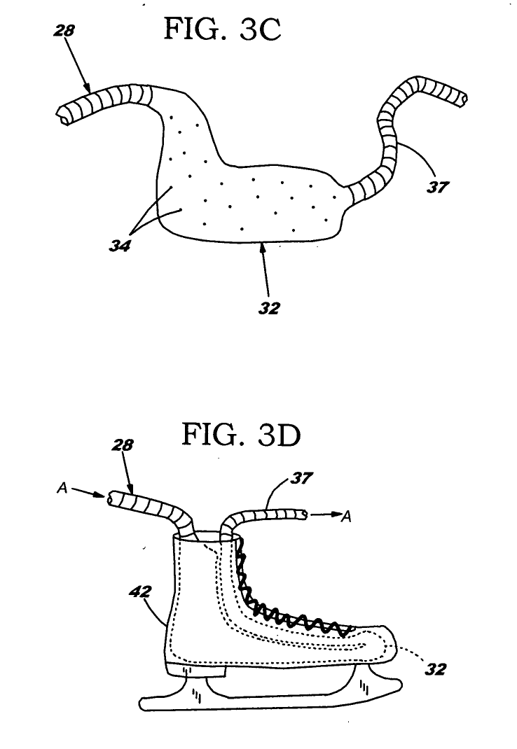

As seen in FIG. 3B, the bladder 32 includes a plurality of vents 34 (previously described) for distributing the air to the interior of the bag. Size and placement of the vents 34 assist in distributing air to desired regions in the interior 12 of the bag 10. Thus, by modifying the location and size of the various vents 34 of the bladder 32 one can control the volume and direct the air to any location in the interior 12 of the bag 10.

Further, the bladder may be formed in any shape desired. As seen in FIG. 2E, and 3A-D, the bladder may take a substantially rectangular shape, such as the floor of the bag, or may take the shape of a specific article 42 that a user would place in the bag. For instance, the bladder 32 may take the shape of an article 42 such as a mitten (FIGS. 2E and 3A), glove, shoe, ice skate (FIG. 3D), or any other article that a user may wish to convey air past for drying or ventilating of the item. As shown in FIG. 3D, the bladder 32 becomes inserted into an article 42 for drying or ventilating the article.

As shown in FIG. 3C, the bladder 32 may include an exhaust conduit 37 for conveying the air through the article 42. This configuration assists in ventilating or drying an article that may be constructed of a fabric or material that is somewhat impervious to natural ventilation. Additionally, the exhaust conduit 37 permits conveyance of the air to another bladder 32, other articles 42, or the interior 12 of the bag 10.

In addition, the bladder may also include a plurality of supports 38 located in the void 33 of the bladder 32. The supports 38 may be formed of an incompressible material, such as polycarbonate, polyethylene, or acrylonitrile butadiene styrene (ABS), or any other material, for separating the first panel 35a from the second panel 35b. As seen in FIG. 3A, the supports 38 may be cube shaped and randomly placed in the bladder 32. Furthermore, as seen in the top view of FIG. 3B, the supports 38 may have a substantially rectangular cross-section defined by sides 39, front edge 41, and back edge 43. In this configuration, the supports may be positioned substantially parallel such that the front edge of each support is substantially parallel with the back edge of the adjacent support. Thus, the supports 38 may include any shape, size or design and become positioned in any order in the bladder 32.

In use, when a load becomes placed on the bladder, the supports 38 prevent the first panel 35a from contacting the second panel 35b. Thus, as seen in FIG. 3B, air may flow from the proximal end 32a to the distal end 32b of the bladder 32. In addition to flowing in the bladder 32, air escapes via the vents 34 and distributes to the interior 12 of the bag 10 even when a user loads the bag with articles. The supports may fixedly attach to the first panel 35a and second panel 35b via heat sealing, gluing, or any other way.

As shown in FIG. 2D, the bladder 32 lays in contact with the panel 16 of the bag 10. The bladder 32 may secure to the panel 16 or end panel 11a, 11b in the interior 12 of the bag 10 via tape, hook and loop fastener, or any other way. Alternatively, the bladder 32 may reside in the interior 12 unsecured to the panel 16, end panel 11a, 11b, or bag 10.

In one embodiment, shown in FIG. 2F, the bag 10 integrally includes the bladder 32 such that the panel 16 or end panel 11a, 11b of the bag functions as the second panel 35b of the bladder and the first panel 35a affixes to the interior 12 of the bag via stitching, gluing, or any other way. The conduit 28 removably or fixedly attaches, via standard tube or hose fittings, heat sealing, welding, taping, or any other way, to the first panel 35a for distribution of air to the bladder. As previously described, the bladder in this configuration may also include a plurality of vents 34 and supports 38. Thus, in this configuration, the bag integrally includes the bladder thereby allowing a user to have the full volume of the bag for storing articles while still enabling air distribution to all areas of the bag.

In addition to the previous description, the conduit 28 may also embody a manifold 36 (FIGS. 2E and 3A). The manifold 36 includes an inlet I, fluidly connected to the air exhaust 26, and a plurality of outlets O for distribution of the air to the interior 12 of the bag 10. The bladder 32 may attach to an outlet of the manifold 36 via standard hose or tube fittings (not shown). Simultaneously, a tube 29 may attach to an outlet O of the manifold 36. Thus, a user may customize the airflow configuration inside the bag by arranging a plurality of tubes, bladders, or other devices for distributing the air. This allows a user to ventilate specific articles, as shown in FIG. 3D, while concurrently distributing air throughout the interior 12 of the bag 10. The manifold 36 may also include caps 48 for covering unused outlets U. Thus, the conduit 28 may be any size, shape, or design for distributing air to the interior of the bag.

The present invention presents a bag that provides active ventilation to the contents of the bag thereby quickly drying the stored articles. Additionally, through use of the bladder having supports, the bag may actively ventilate all portions of the bag regardless of the volume of articles placed in the bag. The bag also provides for a fan powered by a renewable power source for use when away from conventional power supplies and drying equipment.

The foregoing was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A bag having an interior and exterior defined by at least one panel, comprising:
a fan with an air intake and exhaust, the air intake being disposed toward the exterior and the exhaust being disposed toward the interior; and at least one conduit fluidly connected to the exhaust for distributing air from the intake to the interior during use; wherein the fan operates on solar power.

2. The bag of claim 1, wherein the fan attaches to the at least one panel of the bag.

3. The bag of claim 1, wherein the fan is located in the interior and the at least one conduit attaches to the at least one panel of the bag for directing air to the fan air intake.

4. The bag of claim 1, wherein the bag includes a solar collector for supplying the solar power.

5. The bag of claim 4, wherein the solar collector mounts on said fan.

6. The bag of claim 4, wherein the solar collector attaches to a position offset from the fan for providing power to the fan.

7. The bag of claim 1, wherein the bag includes a bladder, having at least one vent, located in the interior and fluidly connected to the at least one conduit.

8. The bag of claim 7, wherein the bladder includes a void defined by at least one panel.

9. The bag of claim 8, wherein the void includes at least one support.

10. The bag of claim 9, wherein the support is substantially incompressible.

11. The bag of claim 10, wherein the bladder is substantially rectangular in shape.

12. The bag of claim 1, wherein the conduit is a manifold having a plurality of outputs and one input fluidly connected to the exhaust.

13. The bag of claim 1, wherein the conduit is a tube having at least one vent for distribution of air to the bag interior.

14. The bag of claim 1, wherein the fan includes a filter for treatment of the air.

15. The bag of claim 14, wherein the filter includes an air freshening reservoir.

16. A bag having an interior and an exterior defined by at least one panel comprising:
a fan with an air intake and exhaust, the air intake being disposed toward the exterior and the exhaust being disposed towards the interior;
a bladder having a first panel, a second panel, and at least one vent; and
at least one conduit fluidly connected to the exhaust and the bladder for distributing air from the intake to the bladder during use.

17. The bag of claim 16, wherein either the first panel or the second panel is the at least one panel.

18. The bag of claim 17, wherein the bladder includes at least one support for separating the first panel from the second panel.

19. The bag of claim 18, wherein the bladder includes a plurality of supports having a substantially parallel spacing.

20. A bag having an interior and an exterior defined by at least one panel comprising:
a solar powered fan with an air intake, exhaust, and filter, the air intake being disposed toward the exterior and the exhaust being disposed towards the interior; and
a manifold having an inlet and a plurality of outlets, whereby the inlet fluidly connects to the exhaust.

21. The bag of claim 20, further comprising a bladder having a first panel and a second panel and at least one vent for distributing air from the intake to the bladder during use, the bladder connects to one of the plurality of outlets.

22. The bag of claim 21, wherein said bladder includes at least one support for separating the first panel from the second panel.

23. The bag of claim 20, further comprising a tube for distributing air from the intake to the interior of the bag.

24. A bag having an interior and an exterior defined by at least one panel comprising:
a solar powered fan with an air intake, exhaust and filter, the air intake being disposed toward the exterior and the exhaust being disposed towards the interior;
a bladder having distal and proximal ends, a first panel and second panel, at least one vent, and a plurality of incompressible supports arranged in the bladder to prevent compression of the bladder when an article becomes placed on one of the first and second panels; and
at least one conduit fluidly connected to the exhaust and bladder for distributing air, wherein air flows from the exhaust through the conduit into the proximal end of the bladder to the distal end of the bladder and out of the vents into the interior.
